(19) United States
(12) Patent Application Publication
(10) Pub. No.: US 2023/0004600 A1
(43) Pub. Date: Jan. 5, 2023

(54) INFORMATION DISPLAY SYSTEM, INFORMATION DISPLAY METHOD, AND INFORMATION DISPLAY PROGRAM

(71) Applicant: SINTOKOGIO, LTD., Nagoya-shi (JP)

(72) Inventors: Takehiro SUGINO, Nagoya-shi (JP); Takashi HANAI, Nagoya-shi (JP); Douta SATO, Nagoya-shi (JP)

(73) Assignee: SINTOKOGIO, LTD., Nagoya-shi (JP)

(21) Appl. No.: 17/849,983

(22) Filed: Jun. 27, 2022

(30) Foreign Application Priority Data
Jun. 30, 2021 (JP) 2021-109094

(51) Int. Cl. G06F 16/901; G06F 16/9038

(52) U.S. Cl. CPC G06F 16/9024; G06F 16/9038

(57) ABSTRACT

An information display system includes: a display; an input device; a control device connected with the display and the input device; and a database configured to associate and store various parameters measured and calculated in a step of producing a cast, wherein the control device includes a graph display control unit configured to refer to the database and display a graph on the display, and an information display control unit configured to display, in response to acceptance of a user operation, information relevant to parameter included in the various parameters and associated with the display parameter at the data point selected by the user operation, on the display.

### CROSS-REFERENCE TO RELATED APPLICATION

This application is based on Japanese Patent Application No. 2021-109094 filed with Japan Patent Office on Jun. 30, 2021, the entire contents of which are hereby incorporated by reference.

### TECHNICAL FIELD

The present disclosure relates to an information display system, an information display method, and an information display program.

### BACKGROUND

Japanese Unexamined Patent Publication No. 2004-230901 discloses a device to display information obtained in an injection molding step, on a screen. This device displays information indicating production achievement ratio and information indicating abnormity occurrence, along a common time axis, and displays presence or absence of molding condition alteration, mold temperature, filling time and change in cushion position, along a common time axis, on the same screen. Thereby, the correlation of the information is displayed in such a way as to be understood at a glance.

### SUMMARY

It is conceivable to apply the device described in Japanese Unexamined Patent Publication No. 2004-230901 to a production step for a cast. The production step for the cast includes a sand treatment step, a molding step, a core step, a melting step, a pouring step, a cooling conveyance step, an after-treatment step and an inspection step, and data measured and calculated in those steps ranges across many kinds. Therefore, the present disclosure provides a technology that efficiently displays a variety of data measured and calculated in the step of producing the cast, on a screen.

An information display system according to an aspect of the present disclosure includes: a display; an input device to accept a user operation; a control device connected with the display and the input device; and a database to associate and store various parameters measured and calculated in a step of producing the cast, wherein the control device includes a graph display control unit to refer to the database and to display a graph on the display, the graph being a graph resulting from plotting a display parameter as a data point, the display parameter being a parameter selected from the various parameters, and an information display control unit to display, when the input device accepts the user operation of selecting the data point of the graph, information relevant to at least one kind of parameter included in the various parameters and associated with the display parameter at the data point selected by the user operation, on the display.

In the information display system, the graph resulting from plotting, as the data point, the display parameter that is the parameter selected from the various parameters measured and calculated in the step of producing the cast is displayed. Then, when the input device accepts the user operation of selecting the data point of the graph for the display parameter, the information relevant to the at least one kind of parameter included in the various parameters and associated with the display parameter at the data point selected by the user operation is displayed on the display. In this way, while displaying information, the information display system displays the information relevant to another kind of parameter associated with the data point selected by the user operation, in response to the user operation, and thereby can display information that a user wants to check, at a timing necessary for the user. Consequently, the information display system can efficiently display a variety of data measured and calculated in the step of producing the cast, on the screen.

In an embodiment, the information display control unit may display information relevant to a parameter included in the various parameters, associated with the display parameter at the data point selected by the user operation, and meeting a previously set display condition, on the display. By configuring the information display system in this way, for example, the information display system can display only information relevant to a parameter necessary for the analysis of the tendency of the display parameter, and therefore can cause the user to know information at which the user should look, at a glance.

In an embodiment, the informations display control unit may emphatically display information relevant to a parameter included in the at least one kind of parameter and meeting a previously set emphasis condition. By configuring the information display system in this way, for example, the information display system can cause the user to visually know a parameter that the user should further check.

In an embodiment, in a case where the data point of the display parameter satisfies an automatic display condition previously set for the display parameter, the information display control unit may display the information relevant to the at least one kind of parameter at the data point, on the display, regardless of the user operation. By configuring the information display system in this way, for example, the information display system can actively display information relevant to the parameter at a data point that is of the data points for the display parameter and that the user should pay attention to, and thereby can cause the user to know the parameter. In an embodiment, in a case where a data point of the display parameter deviates from a permissible range previously set for the display parameter, the information display control unit may determine that the data point satisfies the automatic display condition, and display the information relevant to the at least one kind of parameter at a data point included in data points that satisfy the automatic display condition and most deviating from the permissible range, on the display. By configuring the information display system in this way, the information display system can cause the user to know various parameters at the data point most deviating from the permissible range previously set for the parameter.

In an embodiment, in a case where a previously set display end condition is satisfied, the information display control unit may end display of the parameter displayed by the user operation, and in a case where the user operation of selecting the data point of the graph is a first user operation, the information display control unit may continue the display of the information relevant to the parameter and displayed by the user operation, even in the case where the display end condition is satisfied. By configuring the information display system in this way, the information display system can continue the display of the information relevant to the parameter and displayed by the user operation or can end the display, depending on the user operation.

In an embodiment, in a case where the user operation of selecting the data point of the graph is a user operation of selecting a plurality of data points, the information display control unit may collectively display information relevant to the parameter and related to the plurality of data points, in tabular form. By configuring the information display system in this way, the information display system can compactly display the information relevant to the parameter and relevant to the plurality of data points.

In an embodiment, in response to the user operation of selecting the information relevant to the parameter and displayed on the display, the information display control unit may display a graph on the display, the graph being a graph resulting from plotting the selected parameter as a data point. By configuring the information display system in this way, the information display system can display a graph for another kind of parameter, in response to the user operation.

An information display method according to another aspect of the present disclosure is an information display method for displaying information stored in a database on a display, the database associating and storing various parameters measured and calculated in a step of producing a cast. The information display method comprises the following steps.

(1) A graph display step of displaying a graph on the display, the graph being a graph resulting from plotting a display parameter as a data point, the display parameter being a parameter selected from the various parameters

(2) An information display step of displaying, in response to acceptance of a user operation of selecting the data point of the graph, information relevant to at least one kind of parameter included in the various parameters and associated with the display parameter at the data point selected by the user operation, on the display

An information display program according to yet another aspect of the present disclosure is an information display program to cause a computer to function as a device to display information stored in a database on a display, the database associating and storing various parameters measured and calculated in a step of producing a cast, wherein the information display program causes the computer to function as a graph display control unit to refer to the database and to display a graph on the display, the graph being a graph resulting from plotting a display parameter as a data point, the display parameter being a parameter selected from the various parameters, and an information display control unit to display, in response to acceptance of a user operation of selecting the data point of the graph, information relevant to at least one kind of parameter included in the various parameters and associated with the display parameter at the data point selected by the user operation, on the display.

The above-described information display method and information display program exert the same effect as the above-described information display system.

According to various aspects and embodiments of the present disclosure, it is possible to efficiently display a variety of data measured and calculated in the step of producing the cast, on the screen.

### BRIEF DESCRIPTION OF THE DRAWINGS

FIG. 1 is a block diagram showing the configuration of an information display system according to an exemplary embodiment;

FIG. 2A and FIG. 2B are screen examples for describing an information display manner;

FIG. 3 is a flowchart showing a behavior of the information display system in FIG. 1;

FIG. 4 is a graph showing a relation between CB values and time;

FIG. 5 is a flowchart showing a behavior of the information display system FIG. 1;

FIG. 6A and FIG. 6B are screen examples for describing an information display manner;

FIG. 7 is a flowchart shoring a behavior of the information display system in FIG. 1;

FIG. 8A and FIG. 8B are screen examples for describing an information display mariner; and

FIG. 9A and FIG. 9B are screen examples for describing an information display manner.

### DETAILED DESCRIPTION

An exemplary embodiment of the present disclosure will be described below with reference to the drawings. In the following descriptions, identical or corresponding elements are denoted by identical reference characters, and repetitive descriptions are not repeated.

[Configuration of Information Display System]

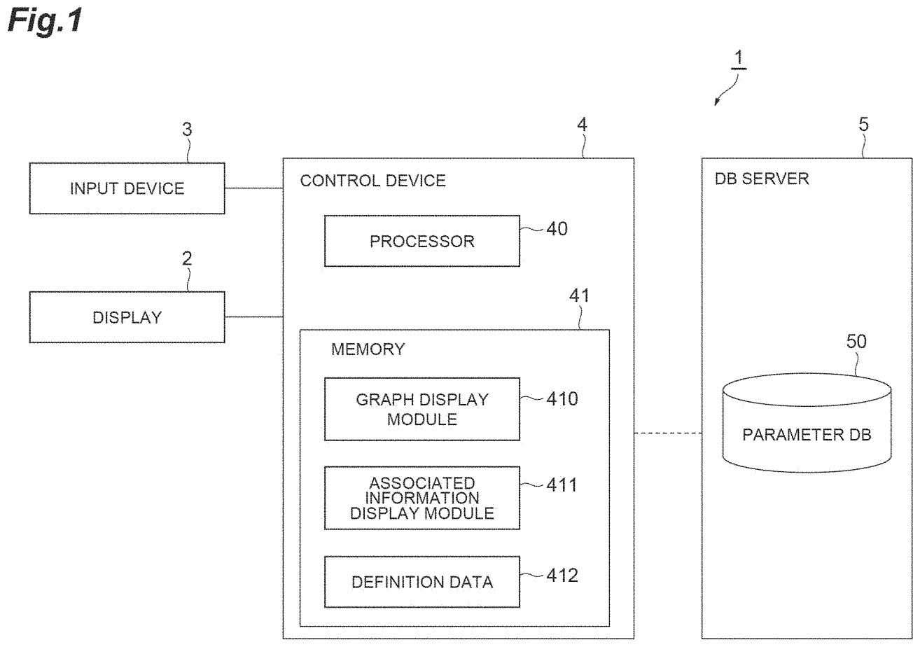

FIG. 1 is a block diagram showing the configuration of an information display system according to an exemplary embodiment. An information display system 1 shown in FIG. 1 is a system that displays information about casting equipment. The casting equipment is equipment that produces a cast, and is equipment by which a sand treatment step, a molding step, a core step, a melting step, a pouring step, a cooling conveyance step, an after-treatment step and an inspection step are executed. The casting equipment that the information display system 1 targets does not need to include all of the above steps, and only needs to include at least one step. As shown in FIG. 1, the information display system 1 includes a display 2, an input device 3, a control device 4 and a DB server 5 (Data base server). The control device 4 is connected with the display 2, the input device 3 and the DB server 5 in a mutually communicable manner.

The display 2 is a device that includes a screen and that displays visual information on the screen for a user such as a worker. The input device 3 is an interface that accepts a user operation, and examples of the input device 3 include a mouse and a keyboard. The input device 3 may be configured as single hardware such as a touch screen, together with the display 2.

The control device 4 includes a processor 40 and a memory 41. The processor 40 is an arithmetic device that supervises the behavior of the control device 4. The memory 41 is a storage medium. The memory 41 stores modules of programs that are executed by the processor 40, definition data and the like. The memory 41 contains a graph display module 410 (an example of the graph display control unit), an associated information display module 411 (an example of the information display control unit) and definition data 4U.

The DB server 5 is a device that contains and manages information collected from the casting equipment. The DB server 5 is configured as a general computer system that includes a CPU (Central Processing Unit), a main storage device such as a RAM (Random Access Memory) and a ROM (Read Only memory), an input device such as a touch panel and a keyboard, an output device such as a display, an auxiliary storage device such as a hard disk, and the like. The DB server 5 includes a parameter DB 50 (an example of the database). The parameter DB 50 associates and stores various parameters measured and calculated in a step of producing the cast. The control device 4 can request information to the DB server 5, can receive the information contained in the parameter DB 50, and can display the information on the display 2.

(Details of Parameter DB)

The parameter DB 50 associates and stores various parameters measured and calculated in the sand treatment step, the molding step, the core step, the melting step, the pouring step, the cooling conveyance step, the after-treatment step and the inspection step. As an example, the parameter DB 50 associates and stores an identifier to be put to a product, measurement data measured in each step and a result (conforming product/non-conforming product) of a product inspection. Examples of the identifier to be put to the product include a product number (character, numeral, sign). The identifier to be put to the product may be formed when molten metal is poured into a mold and thereby an identifier put (marked, for example) on the mold is transferred to the product, or may be directly put (marked, for example) to the product taken out of a mold.

The parameter DB 50 may contain information related to sand property. The information related to the sand property is measured mainly in the sand treatment step. Examples of the information related to the sand property include CB value, moisture, compressive strength, sand temperature, permeability, pouring water amount in a sand mixer, mixing time, atmospheric temperature, humidity, calendar information (day of week, season and the like), equipment state (abrasion status/setting condition/maintenance status of the sand mixer/sand property measurement apparatus and the like), water quality, ratio of new sand and an additive agent, dry state test item (fine powder amount, grain distribution and the like), and operating state (stop time) of a line. The information related to the sand property is linked with a mold (for example, the identifier of a mold) that is being produced, as shift data. The shift data is associated with position information in a mold row, and whenever the mold is moved (conveyed), the shift data is shifted along with the movement. The shifting is displacing the association with the position information in the mold row. For example, the shift data relevant to a mold with a mold identifier N that is positioned at a first position in the row is associated with the first position. In the case where the mold with the mold identifier N moves from the first position to a second position, the association between the shift data relevant to the mold with the mold identifier N and the first position is dissolved along with the movement of the mold with the mold identifier N, and the shift data relevant to the mold with the mold identifier N and the second position are associated.

The parameter DB 50 may contain information related to the mold. The information related to the mold is measured mainly in the molding step. The information related to the mold is information associated with the product and time, and examples of the information related to the mold include mold strength, kneading condition (mixing time, water pouring amount, additive agent addition amount and the like), molding condition (squeeze pressure, squeeze time, sand filling time, sand filling air pressure, sand amount in a sand tank, and the like), and the operating state (stop time) of the line.

The parameter DB 50 may contain information related to pouring. The information related to the pouring is measured mainly in the pouring step. The information related to the pouring is information associated with the product and time (charge), and examples of the information related to the pouring include molten metal temperature, pouring temperature, molten metal conveyance time, holding furnace temperature, ladle temperature and molten metal treatment time (inoculant treatment time, slag-off time and the like). The charge is the unit of one melting, and the molten metal for one charge is poured in a plurality of frames.

The parameter DB 50 may contain information related to the molten metal. The information related to the molten metal is measured mainly in the pouring step. The information related to the molten metal is information associated with the product and time (charge), and examples of the information related to the molten metal include CE value and blending ratio (ratio of scrap material, pig iron and return material) of molten metal materials.

(Example of Information Display Manner)

The control device 4 acquires information from the DB server 5, plats a display parameter as a data point, and displays a graph on the screen of the display 2. The display parameter is a parameter that is selected from various parameters measured and calculated in the step of producing the cast, and is previously determined. A case where the display parameter is fraction defective will be described below. The fraction defective is expressed as the ratio between the number of non-conforming products that do not satisfy a standard previously determined as the product and the number of produced products.

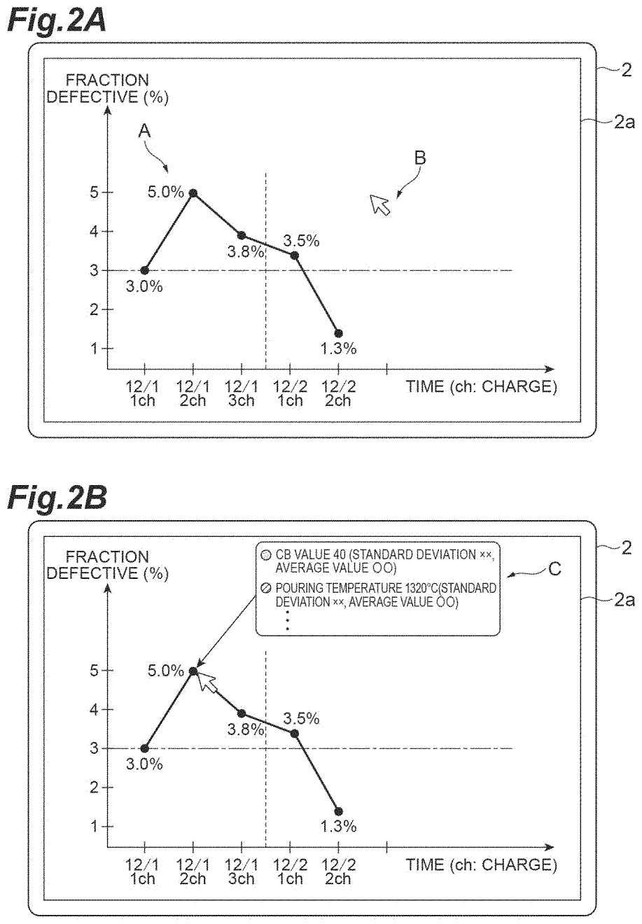

FIG. 2A and FIG. 2B are screen examples for describing an information display manner. As shown in FIG. 2A, for example, the control device .4 adopts the fraction defective (%) as the display parameter, and displays a relation between the fraction defective (%) and time (charge) on a screen 2a of the display 2, as a graph A. The graph A is a line graph in which the abscissa is the time and the ordinate is the fraction defective. The processor 40 of the control device .4 executes the graph display module 410 contained in the memory 41, and thereby displays the graph A on the screen 2a of the display 2. The graph display module 410 is a program that causes the processor 40 to function such that the processor 40 executes a sequence of behaviors for displaying the graph A. Information defining the graph is previously contained in the memory 41 as the definition data 412. The processor 40 may display information (a broken line at a fraction defective of 3% in FIG. 2A) showing a permissible range previously set for the parameter. The information showing the permissible range is previously contained in the memory 41 as the definition data 412.

The processor 40 allows the selection of a data point of the graph A by a user operation, while displaying the graph A. For example, the processor 40 displays a cursor B that the user can operate through the input device 3, on the screen 2a. Then, the processor 40 recognizes the data point selected by the user, acquires information associated with the selected data point, from the DB server 5, and displays the information on the screen 2a. For example, suppose that the user points the cursor B at a certain data point (the time is the second charge on 12/1 and the fraction defective is 5%) and selects the data point as shown in FIG. 2B. When the input device 3 accepts the user operation of selecting the data point of the graph A, the processor 40 displays associated information C relevant to at least one kind of parameter included in the various parameters and associated with the fraction defective at the data point selected by the user operation, on the screen 2a, in a manner of making it possible to recognize that the associated information C is information associated with the data point. The associated information C is information relevant to the various parameters and associated with the display parameter, and is information relevant to a parameter that is previously set for each display parameter. The definition data 412 includes the association between the display parameter and the associated information C, as an association condition. The processor 40 decides the associated information C associated with the display parameter displayed on the display 2, based on the display parameter displayed on the display 2 and the associated condition included in the definition data 412. The processor 40 displays the decided associated information Con the display 2. In the example shown in FIG. 2B, a leading line is displayed from the data point (the time is the second charge on 12/1 and the fraction defective is 5%), and the associated information C including a CB value “40” (standard deviation ××, average value ◯◯), a pouring temperature “1320° C.” (standard deviation ××, average value ◯◯), and the like is displayed.

FIG. 2A and FIG. 2B are examples, and the processor 40 can display all of the information contained in the parameter DB 50, as a graph. Representative display parameters and associated information C that are displayed as a graph will be described below.

(Fraction Defective)

In the case where the display parameter is the fraction defective, the processor 40 may display a graph (the abscissa is the charge and the ordinate is the fraction defective) showing the fraction defective for each charge in a time sequence as described above, or may create and display, for each product, a graph showing the fraction defective in a time sequence. Examples of the associated information C about the fraction defective include all of the measurement data measured in the respective steps.

(Information Related to Sand Property)

As an example, the display parameter related to the sand property is a parameter selected from the CB value, the moisture, the compressive strength, the sand temperature and the permeability. The processor 40 displays a graph (the abscissa is batch and the ordinate is the display parameter) showing the measurement data of the display parameter for each product in a time sequence. The batch is a treatment unit in a sand treatment device. For example, the processor 40 creates a graph for the CB value of a certain product and a graph for the CB value of another product separately. The associated information C about the display parameter related to the sand property is all of the measurement data associated with each parameter. Examples of the measurement data include the pouring water amount in the sand mixer, the mixing time, the atmospheric temperature, the humidity, the calendar information (day of week, season and the like), the equipment state (abrasion status/setting condition/maintenance status of the sand mixer/sand property measurement apparatus and the like), the water quality, the ratio of the new sand and the additive agent, the dry state test item (fine powder amount, grain distribution and the like), and the operating state (stop time) of the line. Information relevant to parameters that are not selected from the group of the display parameter is included in the associated information C. For example, in the case where the CB value is selected as the display parameter, measurement data of the moisture, compressive strength, sand temperature and permeability that are other parameters not selected is the associated information C. The display parameter may be selected from parameters related to the measurement data of the sand property. In this case, the associated information C is the measurement data relevant to parameters that are of the parameters related to the sand property and that are other than the selected parameter.

(Information Related to Mold)

Examples of the display parameter related to the mold include the mold strength. The processor 40 may display a graph (the abscissa is the time and the ordinate is the mold strength) showing the measurement data of the mold strength for each product in a time sequence, or may display a graph showing all of the measurement data of the mold strength in a time sequence instead of showing the measurement data for each product. The associated information C about the display parameter related to the mold is all of the measurement data associated with the mold strength. Examples of the measurement data include the kneading condition (mixing time, water pouring amount, additive agent addition amount and the like), the molding condition (squeeze pressure, squeeze time, sand filling time, sand filling air pressure, sand amount in a sand tank, and the like), the sand property (CB value, moisture, compressive strength, sand temperature, permeability, fine powder amount and active clay content), the abrasion status/maintenance status of a mold strength meter, and the operating state (stop time) of the line. The display parameter may be selected from parameters related to the measurement data about the mold. In this case, the associated information C is the measurement data of the parameter that is other than the selected parameter.

(Information Related to Pouring)

Examples of the display parameter related to the pouring include the pouring temperature. The processor 40 displays a graph (the abscissa is the time and the ordinate is the pouring temperature) showing the measurement data of the pouring temperature in a time sequence. The associated information C is all of the measurement data associated with the molten metal temperature. Examples of the measurement data include the molten metal temperature, the molten metal conveyance time, the holding furnace temperature, the ladle temperature and the molten metal treatment time (inoculant treatment time, slag-off time and the like). The display parameter may be selected from parameters related to the measurement data about the pouring. In this case, the associated information C is the measurement data relevant to a parameter that is of the parameters related to the pouring and that is other than the selected parameter.

(Information Related to Molten Metal)

Examples of the display parameter related to the molten metal include the CE value. The processor 40 may display a graph (the abscissa is the time and the ordinate is the CE value) showing the measurement data of the CE value for each product in a time sequence, or may display a graph showing all of the measurement data of the CE value in a time sequence instead of showing the measurement data for each product. The associated information C is all of the measurement data associated with the CE value. Examples of the measurement data include the blending ratio (ratio of scrap material, pig iron and return material) of molten metal materials. The display parameter may be selected from parameters related to the measurement data about the molten metal. In this case, the associated information C is the measurement data relevant to a parameter that is of the parameter related to the molten metal and that is other than the selected parameter.

The graph that is displayed is not limited to the line graph. The processor 40 can display graphs with different forms, as exemplified by a bar graph and a chart. The processor 40 can alter the coordinate axes when appropriate. For example, the width of the time may be not only charge but also year, month, day or morning/afternoon. Further, the user operation of selecting the data point is not limited to the operation of pointing the cursor B at the data point, and may be an operation of clicking or double-clicking the data point, or may be an operation of tapping or double-tapping the data point in the case of a touch panel, Further, the processor 40 may communicate with the DB server 5 in response to the user operation, and may previously acquire the information associated with the data point at the time of the display of the graph A from the DB server 5, may store the information in the memory 41, and may display the information stored in the memory 41 in response to the user operation.

[Behavior of Information Display System]

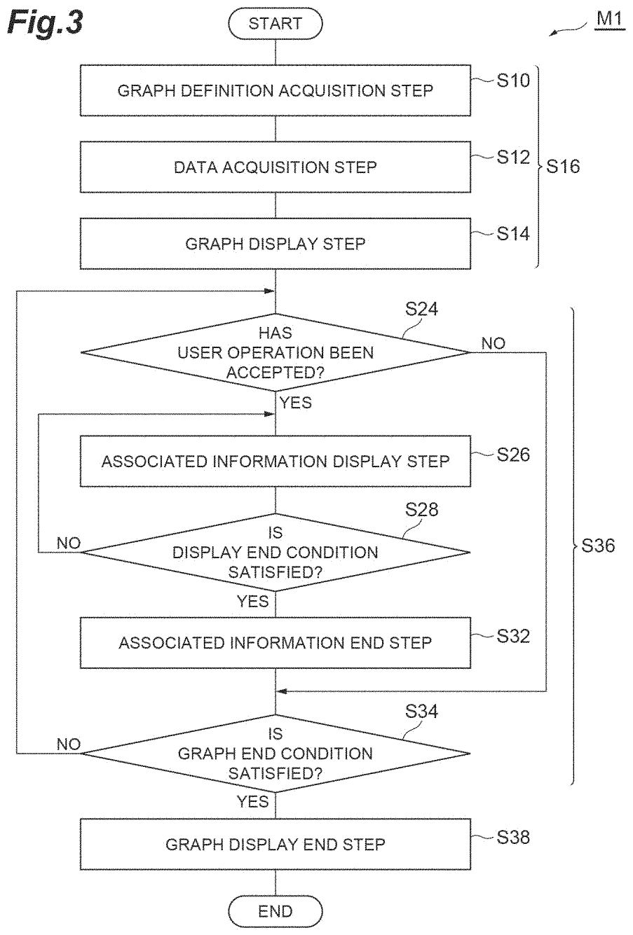

FIG. 3 is a flowchart showing a behavior (an information display method Mi) of the information display system in FIG. 1. The flowchart shown in FIG. 3 is started, for example, at the timing of the acceptance of the user operation for the start of the graph display. The case of displaying the screens shown in FIG. 2A and FIG. 2B will be described below as an example.

As shown in FIG. 3, as a graph definition acquisition step (S10), the processor 40 refers to the definition data 412, and acquires a graph definition. The graph definition is information necessary to draw the graph, and includes information about the display parameter and the abscissa and ordinate of the graph. In the example of FIG. 2A and FIG. 213, the processor 40 acquires information indicating that the display parameter is the fraction defective (percent unit), the abscissa is the time (charge unit) and the ordinate is the fraction defective (percent unit).

Subsequently, as a data acquisition step (S12), the processor 40 communicates with the DB server 5, and acquires the information contained in the parameter DB 50, based on the graph definition. In the example of FIG. 2A and FIG. 2B, the processor 40 acquires the fraction defective. In the parameter DB 50, the identifier put to the product, the measurement data, measured in the respective steps and the result (conforming product/non-conforming product) of the product inspection are associated and stored. The processor 40 refers to the measurement data measured in the respective steps based on the identifier put to the product, and knows when the product was produced. For example, the processor 40 identifies data (pouring time or charge) included in the measurement data and related to the time, and acquires the fraction defective of the product at the corresponding charge, based on the identified data.

Subsequently, as a graph display step (S14), the processor 40 displays the graph A on the screen 2a of the display 2, based on the information acquired in the graph definition acquisition step (S10) and the data acquisition step (S12) (see FIG. 2A). Hereinafter, the graph definition acquisition step (S10), the data acquisition step (S12) and the graph display step (S14) are also collectively referred to as a graph step (S16).

Subsequently, as a determination step (S24), the processor 40 determines whether the user operation has been accepted. The user operation is the operation of selecting the data point of the graph A. The processor 40 determines whether the operation of selecting the data point of the graph A has been accepted, based on the coordinate position of the data point and the coordinate position of the cursor B that the user operates.

In the case where it is determined that the user operation has been accepted (S24: YES), as an associated information display step (S26), the processor 40 displays the information relevant to at least one kind of parameter included in the various parameters and associated with the fraction defective at the data point selected by the user operation, on the screen 2a of the display 2. For example, in the case where the input device 3 has accepted an operation in which the user points the cursor B at a certain data point (the time is the second charge on 12/1 and the fraction defective is 5%) and selects the certain data point as shown in FIG. 2B, the processor 40 communicates with the DB server 5, and acquires the CB value and pouring temperature associated with the fraction defective, and the standard deviations, average values, mean values or others of them, as the associated information C. The associated information C about the fraction defective is not limited to the CB value and pouring temperature. For example, the associated information C about the fraction defective can be set to all of the measurement data measured in the respective steps. The processor 40 displays the associated information C at the data point selected by the user, in a corresponding manner.

Subsequently, as a determination step (S28), the processor 40 determines whether a display end condition is satisfied. The display end condition is a condition about whether to end the display of the associated information, and is previously included in the definition data 412, for example. For example, the definition data 412 contains the display end condition based on the elapsed time from the selection of the data point or the distance between the cursor B and the data point. As an example, in the case where the display end condition is an elapsed time of 5 seconds, the processor 40 counts the elapsed time from the acceptance of the user operation of selecting the data point, and in the case where the elapsed time is within 5 seconds, the processor 40 determines that the elapsed time does not satisfy the display end condition and continues the associated information display step (S26) (S28: NO). In the case where the elapsed time exceeds 5 seconds, the processor 40 determines that the elapsed time satisfies the display end condition, and transitions to an associated information end step (S32) (S28: YES). As the associated information end step (S32), the processor 40 ends the display of the associated information C.

In the case where it is determined that the user operation has not been accepted (S24: NO) or in the case where the associated information end step (S32) ends, the processor 40 determines whether a graph end condition is satisfied, as a determination step (S34). The graph end condition is a condition about whether to end the display of the graph A, and is previously included in the definition data 412, for example. Examples of the graph end condition include a condition that a button for ending the graph display is clicked by the user. In the case where it is determined that the button for ending the graph display has not been clicked, the processor 40 determines that the display end condition for the graph is not satisfied, and executes the processes from the determination step (S24) again (S34: NO). In the case where it is determined that the button for ending the graph display has been clicked, the processor 40 ends the display of the graph A as a graph display end step (S38).

[Summary of Embodiment]

In the information display system 1, the graph resulting from plotting the display parameter that is a parameter selected from the various parameters measured and calculated in the step of producing the cast as the data point is displayed. Then, when the input device 3 accepts the user operation of selecting the data point of the graph for the display parameter, the information relevant to at least one kind of parameter included in the various parameters and associated with the display parameter at the data point selected by the user operation is displayed on the display 2. Furthermore, while displaying the information, the information display system 1 displays the information relevant to another kind of parameter associated with the data point selected by the user operation in response to the user operation, and thereby can display information that the user wants to check, at a timing necessary for the user. Consequently, the information display system 1 can efficiently display a variety of data measured and calculated in the step of producing the cast, on the screen.

The exemplary embodiment has been described above, but various omissions, replacements and alterations may be performed without being limited to the above-described exemplary embodiment.

[Modification 1: Restriction of Display of Associated Information]

When displaying the information relevant to various parameter associated with the display parameter as the associated information, the processor 40 may display only information relevant to a display parameter meeting a display condition, on the screen 2a of the display 2. The display condition is a condition for deciding information to be displayed from the associated information, is previously set, and is contained in the memory 41 as the definition data 412. For example, the associated information C about the fraction defective is all of the measurement data measured in the respective steps, and therefore, in the case of the display of the associated information C, the associated information C may not fit within the screen in some cases. Therefore, the processor 40 selects only information relevant to a display parameter meeting the display condition from the associated information C, and displays the information on the screen 2a of the display 2. In the example shown in FIG. 2B, examples of the parameter meeting the display condition for the fraction defective are the CB value and the pouring temperature. With such a configuration, the processor 40 can perform adjustment such that the associated information C is displayed within the screen 2a, even in the case of many kinds of associated information C. Further, it is possible to previously determine the display condition such that only a parameter necessary for the analysis of the tendency of the display parameter is included. Thereby, the processor 40 can display only the parameter necessary for the analysis of the tendency of the display parameter, and can cause the user to know information at which the user should look, at a glance. Alternatively, the display condition may be set for each display parameter, such that the display parameter is displayed as the associated information C in the case where the display parameter deviates from an upper or lower limit value of a threshold value (for example, mold strength: 10 to 25 N/cm²) by a predetermined value (for example, mold strength: 5 N/cm²) or more. There are sometimes a plurality of measurement values that are compared with the threshold value. For example, in the case where the molten metal for one charge is poured into a plurality of molds, there is a mold strength for each of the plurality of molds. In such a case, the processor 40 compares the average value of the plurality of measurement values and the threshold value. Instead of the average value, the processor 40 may use various values such as the maximum value, the minimum value, a value that most deviates from a permissible range previously set for the parameter, and the standard deviation.

[Modification 2: Emphasis Display of Associated Information]

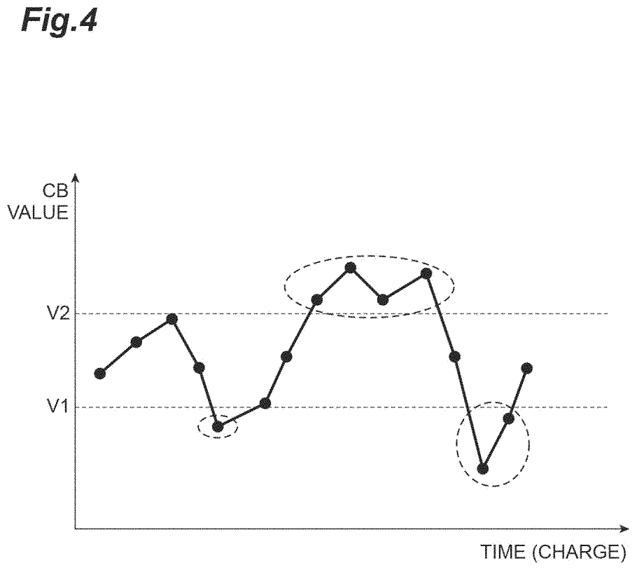

The processor 40 may emphasize and display the associated information that satisfies an emphasis condition. The emphasis condition is a condition for deciding information that is of the information included in the associated information and that is emphatically displayed, is previously set, and is contained in the memory 41 as the definition data 412, for example. The definition data 412 also includes the manner of the emphasis. Examples of the manner of the emphasis include increasing sizes of characters in the associated information, increasing thicknesses of the characters, putting a symbol mark, and displaying highlight. The symbol mark may be a triangular figure that surrounds an exclamation mark, or may be a circular figure. The size and thickness of the character, the color of the symbol mark, and the intensity of the highlight display (the shade of color) may be altered depending on the level of the emphasis. For example, the processor 40 puts a yellow symbol mark to associated information that is intended to be emphasized, and puts a red symbol mark to associated information that is intended to be further emphasized. Similarly to the display condition, the emphasis condition may target the parameter necessary for the analysis of the tendency of the display parameter. Alternatively, the emphasis condition may target a parameter having data that deviates from a permissible range previously set for the parameter. FIG. 4 is a graph showing a relation between the CB values and the time. As shown in FIG. 4, the processor 40 may calculate a ratio at which the measured CB values deviate from a permissible range previously set for the CB value (a value resulting from dividing the number of frames for which the measured CB values deviate from a permissible range previously set for the CB value by the number of frames for one charge), may emphatically display the CB value that is the associated information, at a first emphasis level, in the case where the ratio is 5% or more and less than 10%, and may emphatically display the CB value that is the associated information, at a second emphasis level higher than the first emphasis level, in the case where the ratio is 10% or more. Alternatively, the processor 40 may emphatically display the parameter, in the case where the measurement data deviates by a predetermined numerical range or more from an upper or lower limit value of a permissible range previously set for the parameter. For example, the processor 40 emphatically displays the CB value that is the associated information, in the case where the CB value that is the associated information deviates by 3 to 5 from an upper or lower limit value of a permissible range previously set for the CB value. Alternatively, instead of the above-described ratio, the processor 40 may alter the emphasis level depending on a distance by which the measurement data deviates from an upper or lower limit value of a permissible range previously set for the parameter. For example, the processor 40 puts a yellow symbol mark to the CB value that is the associated information, in the case where the measurement data of the CB value deviates by 3 from the upper or lower limit value of the permissible range previously set for the CB value, and puts a red symbol mark to the CB value that is the associated information, in the case where the measurement data of the CB value deviates by 5 from the upper or lower limit value of the permissible range previously set for the CB value. By configuring the information display system 1 in this way, for example, the information display system 1 can cause the user to visually know a parameter that the user should further check. Alternatively, the emphasis condition may be satisfied, for example, in the case where the average value for one charge deviates by a predetermined value that is previously set. Instead of the average value, the emphasis condition may be set using various values such as the maximum value, the minimum value and the standard deviation.

[Modification 3: Automatic Display of Associated Information]

The processor 40 may automatically display the associated information regardless of the user operation. For example, in the case where the measurement data of the display parameter satisfies an automatic display condition previously set for the display parameter, the processor 40 displays the associated information C about the measurement data on the display 2, regardless of the user operation. The automatic display condition is previously set for the display parameter, and is contained in the memory 41 as the definition data 412, for example. As an example, the automatic display condition is set such that the automatic display condition is satisfied in the case where the measurement data of the display parameter deviates from a previously set permissible range. The processor 40 may display the associated information C about measurement data included in the measurement data of the display parameter that satisfies the automatic display condition and most deviating from the permissible range, on the display 2. For example, suppose that the permissible range previously set for the fraction defective that is the display parameter is 3.0% or less in the graph A shown in FIG. 2A. In this case, the processor 40 determines that a data point (the time is the second charge on 12/1) at a fraction defective of 5.0%, a data point (the time is the third charge on 12/1) at a fraction defective of 3.8%, and a data point (the time is the first charge on 12/2) at a fraction defective of 3.5% satisfy the automatic display condition. The processor 40 may automatically display the associated information C at these data points regardless of the user operation, or may automatically display the associated information C at only the data point (the time is the second charge on 12/1) at the fraction defective of 5.0% that most deviates from the permissible range regardless of the user operation.

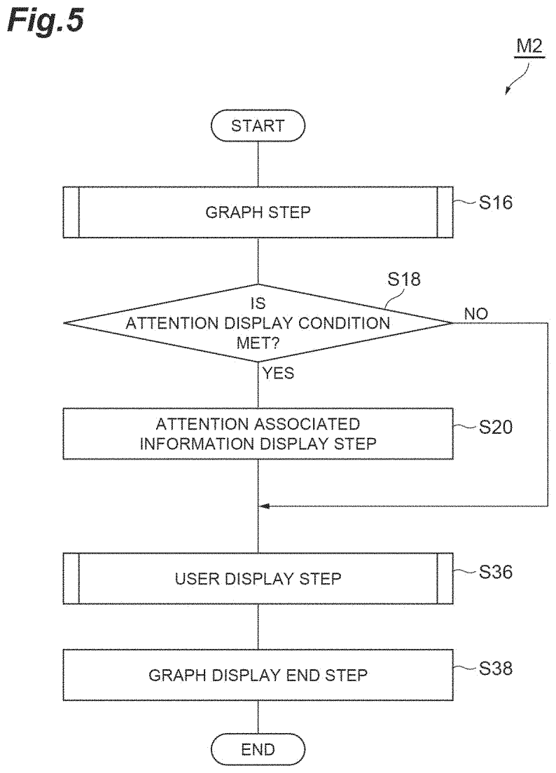

The processor 40 may display information relevant to a parameter meeting a previously set attention display condition, as the associated information, regardless of the user operation. The attention display condition is a condition for deciding information that is of the information included in the associated information and that is displayed regardless of the user operation, is previously set, and is contained in the memory 41 as the definition data 412, for example. The attention display condition can target a parameter having data that deviates from a permissible range previously set for the parameter. FIG. 5 is a flowchart showing a behavior (an information display method M2) of the information display system in FIG. 1 The flowchart shown in FIG. 5 is started, for example, at the timing of the acceptance of the user operation for the start of the graph display. The same processes as FIG. 3 are denoted by the same reference characters, and detailed descriptions are not repeated. The case of displaying the screens shown in FIG. 2A and FIG. 2B will be described below as an example.

As shown in FIG. 5, the processor 40 executes the graph step (S16) (see FIG. 3). Thereby, the graph is displayed on the screen 2a of the display 2. Subsequently, as a determination step (S18), the processor 40 determines whether the attention display condition is met. The processor 40 acquires the associated information associated with the fraction defective, and determines whether the attention display condition is met. For example, in the case where the associated information is the CB value, a permissible range V1-V2 is set for the CB value, as shown in FIG. 4. The CB value shown in FIG. 4 includes data that deviates from the permissible range V1-V2. Therefore, the processor 40 determines that the CB value meets the attention display condition (S18: YES). Then, as an attention associated information display step (S20), the processor 40 displays the CB value on the screen 2a of the display 2.

In the case where the attention associated information display step (S20) ends or in the case where it is determined that the associated information does not meet the attention display condition (S18: NO), the processor 40 executes a user display step (S36), and displays the associated information corresponding to the user operation (see FIG. 3). Then, the processor 40 executes the graph display end step (S38), and ends the display of the graph (see FIG. 3).

By executing the flowchart shown in FIG. 5, the information display system 1 can actively display information relevant to a parameter that the user should particularly check, as exemplified by a parameter that deviates from the permissible range previously set for the parameter, and can cause the user to know the parameter. The information display system 1 may display a parameter included in the parameters that meet the attention display condition and having data that most deviates from the permissible range previously set for the parameter (a parameter in the associated information for which the relatively deviating distance is large). In this case, the information display system 1 can constantly display the information relevant to the parameter having data that most deviates from the permissible range previously set for the parameter, and can cause the user (worker) to visually recognize the information.

[Modification 4: Simultaneous Display of Associated Information]

In the above-described embodiment, in the case where the previously set display end condition is satisfied, the associated information stops being displayed. For example, when the user takes off the cursor B from the selected data point, the associated information stops being displayed after a certain time. The processor 40 may devise the display of the associated information for easily comparing pieces of associated information that are associated with data points. In the case where the user operation of selecting the data point of the graph is a first user operation, the processor 40 may continue the display of the information relevant to the parameter and displayed by the user operation, even in the case of satisfying the previously set display end condition. That is, in the case where the operation of selecting the data point is the first user operation, the associated information continues to be displayed. The user operation can be arbitrarily set. For example, in the case of selecting the data point by clicking, the associated information stops being displayed in the case of satisfying the display end condition, and in the case of selecting the data point by double-clicking, the display is continued even in the case of satisfying the display end condition. The first user operation is not particularly limited if being distinguishable from the user operation for which the associated information stops being displayed in the case of satisfying the display end condition, and an appropriate operation such as long-pressing, right-clicking, double-tapping and clicking while pressing a Ctrl key is set. The first user operation is previously set, and is contained in the memory 41 as the definition data 412, for example.

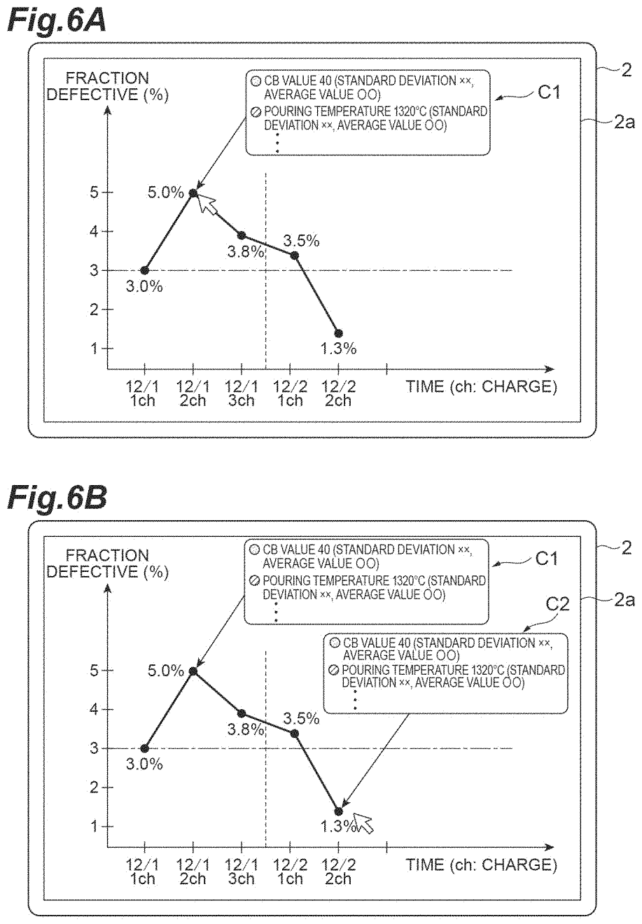

FIG. 6A and FIG. 6B are screen examples for describing an information display manner. Suppose that the user points the cursor at a certain data point (the time is the second charge on 12/1 and the fraction defective is 5%) and selects the data point by double-clicking (an example of the first user operation) as shown in FIG. 6A. When the input device 3 accepts the user operation of selecting the data point of the graph, the processor 40 displays associated information C1 including various parameters associated with the fraction defective at the data point selected by the user operation, on the screen 2a, in a manner of making it possible to recognize that the associated information C1 is information associated with the data point. Specifically, a leading line is displayed from the data point (the time is the second charge on 12/1 and the fraction defective is 5%), and the associated information C1 including a CB value “40” (standard deviation ××, average value ◯◯), a pouring temperature “1320° C.” (standard deviation ××, average value ◯◯), and the like is displayed. The processor 40 constantly displays the associated information C1, even when the associated information C1 satisfies the display end condition. Subsequently, suppose that the user points the cursor at a next data point (the time is the second charge on 12/2 and the fraction defective is 1.3%) and selects the data point by double-clicking (an example of the first user operation) as shown in FIG. 6B. In this case, associated information C2 is displayed. At this time, the associated information C1 and the associated information C2 are simultaneously displayed on the same screen 2a.

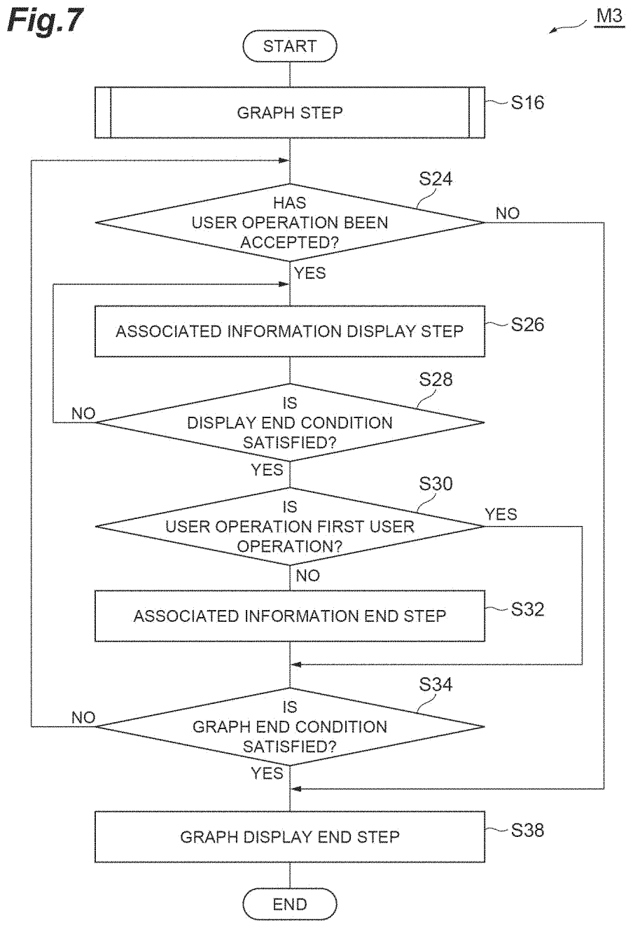

FIG. 7 is a flowchart showing a behavior (an information display method M3) of the information display system in FIG. 1. The flowchart shown in FIG. 7 is started, for example, at the timing of the acceptance of the user operation for the start of the graph display. The same processes as FIG. 3 are denoted by the same reference characters, and detailed descriptions are not repeated. The case of displaying the screens shown in FIG. 6A and FIG. 6B will be described below as an example.

As shown in FIG. 7, the processor 40 executes the graph step (S16) (see FIG. 3). Thereby, the graph is displayed on the screen 2a of the display 2. Subsequently, the processor 40 sequentially executes the determination step (S24), the associated information display step (S26) and the determination step (S28) (see FIG. 3). Thereby, as shown in FIG. 6A, the associated information C1 is displayed on the screen 2a. Subsequently, as a determination step (S30), the processor 40 determines whether the user operation is the first user operation. The processor 40 refers to the definition data 412, and determines whether the user operation for displaying the associated information C1 is the first user operation. For example, in the case where the first user operation is the double-clicking and where the user has selected the data point for displaying the associated information C1 by clicking, the processor 40 determines that the user operation is not the first user operation. In this case, as the associated information end step (S32), the processor 40 ends the display of the associated information C1. On the other hand, for example, in the case where the first user operation is the double-clicking and where the user has selected the data point for displaying the associated information C1 by double-clicking, the processor 40 determines that the user operation is the first user operation. In this case, the processor 40 skips the associated information end step (S32). Thereby, the display of the associated information C1 is continued even in the case where the user selects another data point. Then, the processor 40 executes the graph display end step (S38), and ends the display of the graph (see FIG. 3).

In the case of ending the display of the associated information in the middle, the processor 40, for example, may display a cancel button at an upper right portion in a display region for the associated information, and may end the display of the associated information when the cancel button is pressed. Further, the processor 40 may select the parameter in the associated information, such that the parameters of the associated information C1 and the associated information C2 that are simultaneously displayed are common. Alternatively, in the case where the processor 40 displays associated information about a data point for which it is determined that the result is out of a previously set permissible range (rejection) and associated information about a data point for which it is determined that the result is within the previously set permissible range (acceptance), the parameter in the associated information is selected such that the associated information about the data point for which the result is accepted includes the parameter in the associated information about the data point for which the result is rejected.

By executing the flowchart shown in FIG. 7, the information display system 1 can continue the display of the parameter displayed by the user operation or end the display, depending on the user operation.

[Modification 5: Comparative Display of Associated Information]

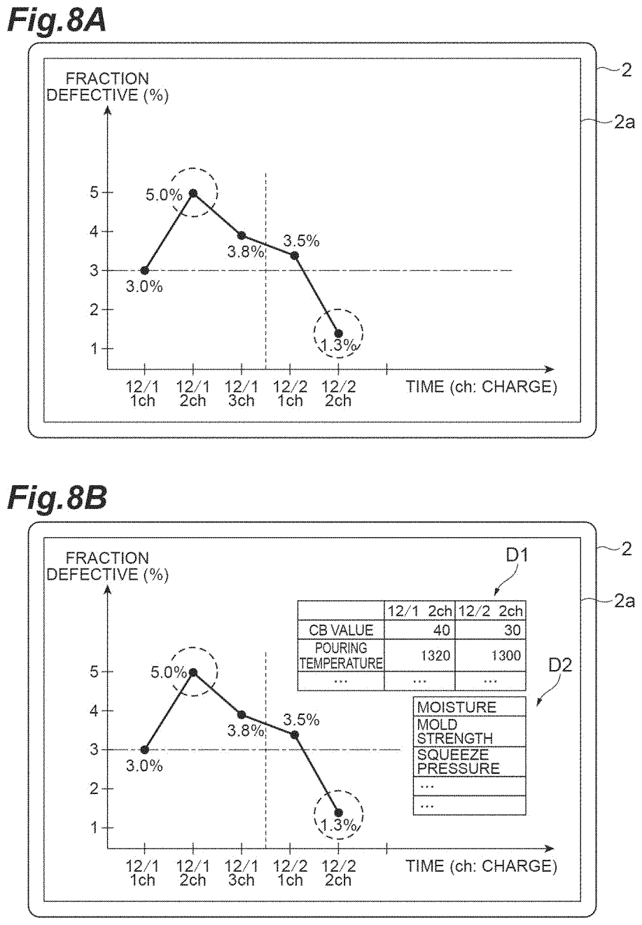

The processor 40 may further devise the display of the associated information for easily comparing pieces of associated information that are associated with data points. For example, in the case where the user operation of selecting the data point of the graph is a user operation of selecting a plurality of data points, the processor 40 may collectively display information relevant to the parameter and related to the plurality of data points, in tabular form. For example, the user operation of selecting a plurality of data points is an operation of clicking a plurality of data points at a predetermined time interval. Alternatively, the user operation of selecting a plurality of data points is an operation of clicking a plurality of data points while pressing a CTRL key. FIG. 8A and FIG. 8B are screen examples for describing an information display manner Suppose that a data point (the time is the second charge on 12/1 and the fraction defective is 5%) and a data point (the time is the second charge on 12/2 and the fraction defective is 1.3%) surrounded by broken lines are selected by the user as shown in FIG. 8A. In this case, the processor 40 collectively displays parameters for the associated information about the two data points in a table D1. Furthermore, the processor 40 may display a selection table D2 in such a way to allow also another parameter to be added in the comparative table, and may allow the selection of a parameter that is added in the table D1. By configuring the information display system 1 in this way, the information display system 1 can compactly display the parameter relevant to a plurality of data points.

[Modification 6: Detail Display of Associated Information]

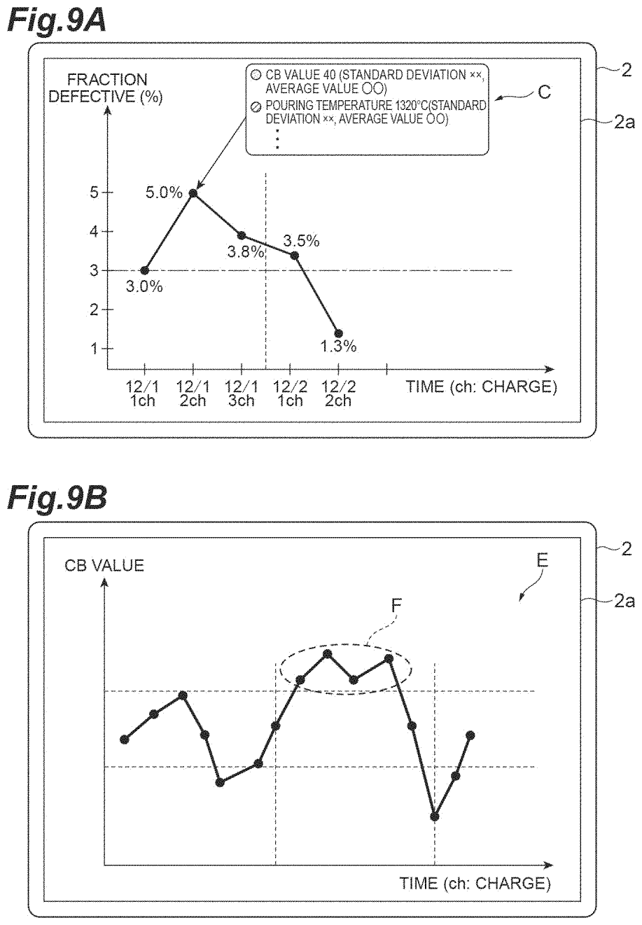

The processor 40 may put a link to the associated information, and may allow the selection of the parameter in the associated information. Then, in response to the user operation of selecting the parameter in the associated information that is displayed on the display 2, the processor 40 may display a graph resulting from plotting the selected parameter as the data point, on the display 2. FIG. 9A and FIG. 9B are screen examples for describing an information display manner As shown in FIG. 9A, the CB value and the pouring temperature are shown as the associated information C. Links are put to the parameters in the associated information C. The processor 40 displays a graph for a parameter selected by the user operation, on the screen 2a of the display 2. For example, in the case where the CB value in the associated information C shown in FIG. 9A is selected by the user, a graph E showing the relation between the CB value and the time is displayed as shown in FIG. 9B. A data point group F shown by a broken line in the graph E is information about the CB value displayed as the associated information C and values around that. The processor 40 may cause the screen to transition for displaying the graph E, or may divide the screen 2a into two screens and may display the original graph and the graph E. By configuring the information display system 1 in this way, the information display system I can display a graph for another kind of parameter, in response to the user operation. Further, the information display system 1 can cause the user to know detailed information by a simple operation, and therefore can enhance convenience.

[Other Modifications]

The information display system 1 may be configured such that a plurality of devices are connected through communication, or may be configured as a single device. The function of the control device 4 may function as an information display program. The information display program may be provided while being contained in a computer-readable storage medium.

### REFERENCE SIGNS LIST

1 . . . information display system, 2 . . . display, 3 . . . input device, 50 . . . parameter DB, 410 . . . graph display module (an example of the graph display control unit), 411 . . . associated information display module (an example of the information display control unit), 412 . . . definition data

What is claimed is:

1. An information display system to display information related to production of a cast, the information display system comprising:
a display;
an input device configured to accept a user operation;
a control device connected with the display and the input device; and
a database configured to associate and store various parameters measured and calculated in a step of producing the cast, wherein
the control device includes
a graph display control unit configured to refer to the database and display a graph on the display, the graph being a graph resulting from plotting a display parameter as a data point, the display parameter being a parameter selected from the various parameters, and
an information display control unit configured to display, in response to acceptance of a user operation of selecting the data point of the graph by the input device, information relevant to at least one kind of parameter included in the various parameters and associated with the display parameter at the data point selected by the user operation, on the display.

2. The information display system according to claim 1, wherein the information display control unit displays information relevant to a parameter included in the various parameters, the information associated with the display parameter at the data point selected by the user operation, the information meeting a previously set display condition, on the display.

3. The information display system according to claim 1, wherein the information display control unit emphatically displays information relevant to a parameter included in the at least one kind of parameter and meeting a previously set emphasis condition.

4. The information display system according to claim 2, wherein the information display control unit emphatically displays information relevant to a parameter included in the at least one kind of parameter and meeting a previously set emphasis condition.

5. The information display system according to claim 1, wherein in a case where the data point of the display parameter satisfies an automatic display condition previously set for the display parameter, the information display control unit displays the information relevant to the at least one kind of parameter at the data point, on the display, regardless of the user operation.

6. The information display system according to claim 2, wherein in a case where the data point of the display parameter satisfies an automatic display condition previously set for the display parameter, the information display control unit displays the information relevant to the at least one kind of parameter at the data point, on the display, regardless of the user operation.

7. The information display system according to claim 3, wherein in a case where the data point of the display parameter satisfies an automatic display condition previously set for the display parameter, the information display control unit displays the information relevant to the at least one kind of parameter at the data point, on the display, regardless of the user operation.

8. The information display system according to claim 4, wherein in a case where the data point of the display parameter satisfies an automatic display condition previously set for the display parameter, the information display control unit displays the information relevant to the at least one kind of parameter at the data point, on the display, regardless of the user operation.

9. The information display system according to claim 5, wherein in a case where a data point of the display parameter deviates from a permissible range previously set for the display parameter, the information display control unit determines that the data point satisfies the automatic display condition, and displays the information relevant to the at least one kind of parameter at a data point included in data points that satisfy the automatic display condition and most deviating from the permissible range, on the display.

10. The information display system according to claim 6, wherein in a case where a data point of the display parameter deviates from a permissible range previously set for the display parameter, the information display control unit determines that the data point satisfies the automatic display condition, and displays the information relevant to the at least one kind of parameter at a data point included in data points that satisfy the automatic display condition and most deviating from the permissible range, on the display.

11. The information display system according to claim 7, wherein in a case where a data point of the display parameter deviates from a permissible range previously set for the display parameter, the information display control unit determines that the data point satisfies the automatic display condition, and displays the information relevant to the at least one kind of parameter at a data point included in data points that satisfy the automatic display condition and most deviating from the permissible range, on the display.

12. The information display system according to claim 8, wherein in a case where a data point of the display parameter deviates from a permissible range previously set for the display parameter, the information display control unit determines that the data point satisfies the automatic display condition, and displays the information relevant to the at least one kind of parameter at a data point included in data points that satisfy the automatic display condition and most deviating from the permissible range, on the display.

13. The information display system according to claim 1, wherein
in a case where a previously set display end condition is satisfied, the information display control unit ends display of the information relevant to the parameter and displayed by the user operation, and
in a case where the user operation of selecting the data point of the graph is a first user operation, the information display control unit continues the display of the information relevant to the parameter and displayed by the user operation, even in the case where the previously set display end condition is satisfied.

14. The information display system according to claim 2, wherein
in a case where a previously set display end condition is satisfied, the information display control unit ends display of the information relevant to the parameter and displayed by the user operation, and
in a case where the user operation of selecting the data point of the graph is a first user operation, the information display control unit continues the display of the information relevant to the parameter and displayed by the user operation, even in the case where the previously set display end condition is satisfied.

15. The information display system according to claim 3, wherein
in a case where a previously set display end condition is satisfied, the information display control unit ends display of the information relevant to the parameter and displayed by the user operation, and
in a case where the user operation of selecting the data point of the graph is a first user operation, the information display control unit continues the display of the information relevant to the parameter and displayed by the user operation, even in the case where the previously set display end condition is satisfied.

16. The information display system according to claim 4, wherein
in a case where a previously set display end condition is satisfied, the information display control unit ends display of the information relevant to the parameter and displayed by the user operation, and
in a case where the user operation of selecting the data point of the graph is a first user operation, the information display control unit continues the display of the information relevant to the parameter and displayed by the user operation, even in the case where the previously set display end condition is satisfied.

17. The information display system according to claim 1, wherein in a case where the user operation of selecting the data point of the graph is a user operation of selecting a plurality of data points, the information display control unit collectively displays information relevant to the parameter and related to the plurality of data points, in tabular

18. The information display system according to claim 1, wherein in response to the user operation of selecting the information relevant to the parameter and displayed on the display, the information display control unit displays a graph on the display, the graph being a graph resulting from plotting the selected parameter as a data point.

19. An information display method for displaying information stored in a database on a display, the database associating and storing various parameters measured and calculated in a step of producing a cast, the information display method comprising:
displaying a graph on the display, the graph being a graph resulting from plotting a display parameter as a data point, the display parameter being a parameter selected from the various parameters; and
displaying, in response to acceptance of a user operation of selecting the data point of the graph, information relevant to at least one kind of parameter included in the various parameters and associated with the display parameter at the data point selected by the user operation, on the display.

20. An information display program to cause a computer to function as a device to display information stored in a database on a display, the database associating and storing various parameters measured and calculated in a step of producing a cast, wherein
the information display program causes the computer to function as
a graph display control unit configured to refer to the database and display a graph on the display, the graph being a graph resulting from plotting a display parameter as a data point, the display parameter being a parameter selected from the various parameters, and
an information display control unit configured to display, in response to acceptance of a user operation of selecting the data point of the graph, information relevant to at least one kind of parameter included in the various parameters and associated with the display parameter at the data point selected by the user operation, on the display.
